(19) United States
(12) Patent Application Publication
(10) Pub. No.: US 2013/0182611 A1
(43) Pub. Date: Jul. 18, 2013

(54) COORDINATION OF DISCOVERY RESPONSES

(71) Applicant: Nokia Corporation, Espoo (FI)

(72) Inventors: Jarkko KNECKT, Espoo (FI); Mika Kasslin, Espoo (FI); Eng Hwee Ong, Choa Chu Kang (SG)

(73) Assignee: Nokia Corporation, Espoo (FI)

(21) Appl. No.: 13/735,413

(22) Filed: Jan. 7, 2013

Related U.S. Application Data
(60) Provisional application No. 61/586,185, filed on Jan. 13, 2012.

(51) Int. Cl. H04W 48/16; H04W 36/00; H04W 48/20

(52) U.S. Cl. CPC H04W 48/16; H04W 48/20; H04W 36/0061
USPC 370/255; 370/328; 370/311; 370/331

(57) ABSTRACT

Disclosed are various methods and apparatus usable in, for example, an IEEE 802.11 type of wireless network. An exemplary method includes transmitting a probe request frame from a station; receiving a probe response frame from an access point; and examining the received probe response frame to determine whether an order in which probe response frames are received from the access point and from other access points has been coordinated and that the station is recommended to attempt to authenticate and associate to the access points according to the order in which the probe response frames are received. Related embodiments of access points and a discovery management entity are also disclosed.

### CLAIM OF PRIORITY FROM COPENDING PROVISIONAL PATENT APPLICATION

This patent application claims priority under 35 U.S.C. §119(e) from Provisional Patent Application No. 61/586,185, filed Jan. 13, 2012, the disclosure of which is incorporated by reference herein in its entirety including all Exhibits appended to Provisional Patent Application No. 61/586,185.

### TECHNICAL FIELD

The exemplary and non-limiting embodiments of this invention relate generally to wireless communication systems, methods, devices and computer programs and, more specifically, relate to network discovery protocols and procedures.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

In many types of less communication networks a user terminal or station will scan its radio environment in order to locate a suitable network access point or node to establish a communication link. It is desirable to make the scanning process and the receipt of resulting response(s) from one or more of the access nodes as efficient as possible in order to minimize delays inherent in connecting the terminal or station to a suitable access node in order to establish the communication link.

### SUMMARY

In one non-limiting aspect thereof the examples of the embodiments of this invention provide a method that comprises receiving at least one probe request received frame from at least one reporting access point; processing information contained in the at least one received probe request received frame to determine at least one access point of a selected set of access points that should respond to a probe request frame transmitted by a station; and sending at least one response transmission order frame to the at least one access point, the response transmission order frame containing information for use by the at least one access point in sending a probe response frame to the station.

In another non-limiting aspect thereof the examples of the embodiments of this invention provide an apparatus that comprises at least one processor and at least one memory including computer program code. The memory and computer program code are configured to, with the at least one processor, cause the apparatus at least to receive at least one probe request received frame from at least one reporting access point; process information contained in the at least one received probe request received frame to determine at least one access point of a selected set of access points that should respond to a probe request frame transmitted by a station; and send at least one response transmission order frame to the at least one access point, the response transmission order frame containing information for use by the at least one access point in sending a probe response frame to the station.

In another non-limiting aspect thereof the examples of the embodiments of this invention provide a method that comprises receiving a probe request frame from a station; sending a probe request received frame to a discovery management entity; receiving a response transmission order frame from the discovery management entity; and transmitting a probe response frame to the station based at least in part on information contained within the response transmission order frame.

In yet another non-limiting aspect thereof the examples of the embodiments of this invention provide an apparatus that comprises at least one processor and at least one memory including computer program code. The memory and computer program code are configured to, with the at least one processor, cause the apparatus at least to receive a probe request frame from a station; send a probe request received frame to a discovery management entity; receive a response transmission order frame from the discovery management entity; and transmit a probe response frame to the station based at least in part on information contained within the response transmission order frame.

In still another non-limiting aspect thereof the examples of the embodiments of this invention provide a method that comprises transmitting a probe request frame from a station; receiving a probe response frame from an access point; and examining the received probe response frame to determine whether an order in which probe response frames are received from the access point and from other access points has been coordinated and that the station is recommended to attempt to authenticate and associate to the access points according to the order in which the probe response frames are received.

In yet another non-limiting aspect thereof the examples of the embodiments of this invention provide an apparatus that comprises at least one processor and at least one memory including computer program code. The memory and computer program code are configured to, with the at least one processor, cause the apparatus at least to transmit a probe request frame from a station; receive a probe response frame from an access point; and examine the received probe response frame to determine whether an order in which probe response frames are received from the access point and from other access points has been coordinated and that the station is recommended to attempt to authenticate and associate to the access points according to the order in which the probe response frames are received.

### BRIEF DESCRIPTION OF THE DRAWINGS

FIG. 1A reproduces FIG. 1 of PCT/US11/58346 and shows a general architecture of a wireless telecommunication system to which embodiments of the invention may be applied.

FIG. 1B shows another example of an exemplary architecture in which the embodiments of this invention can be used.

FIG. 2 shows an example of a signaling diagram to achieve probe response coordination in accordance with non-limiting examples of embodiments of this invention.

FIG. 3 shows an exemplary signaling diagram to achieve probe response coordination, where a probe response from AP2 includes information of AP1.

FIG. 4 shows a Probe Response frame containing new information elements in accordance with the non-limiting examples of embodiments of this invention.

FIG. 5 shows a simplified block diagram of various electronic devices that are suitable for use in practicing the non-limiting examples of embodiments of this invention.

FIG. 6 is a logic flow diagram that illustrates the operation of a method, and a result of execution of computer program instructions, in accordance with the non-limiting examples of embodiments of this invention.

FIG. 7 is a logic flow diagram that illustrates the operation of a further method, and a result of execution of computer program instructions, in accordance with the non-limiting examples of embodiments of this invention.

FIG. 8 is a logic flow diagram that illustrates the operation of yet another method, and a result of execution of computer program instructions, further in accordance with the non-limiting examples of embodiments of this invention.

FIG. 9 shows an example of a signaling diagram that employs a Probe End frame transmitted by a station to inhibit the sending of Probe Response frames in accordance with non-limiting examples of embodiments of this invention.

FIG. 10 shows an example of a signaling diagram where an ESS Server is connected to APs operating in different channels in accordance with non-limiting examples of embodiments of this invention.

### DETAILED DESCRIPTION

An IEEE 802.11ai task group is currently defining principles for fast Initial Link Setup (FILS). The FILS is to be achieved at least in part by reducing the delays involved in active scanning and in association and authentication. A goal of the IEEE 802.11ai task group is to define improvements to discovery procedures that enable devices to reduce the amount of signaling during active scanning and to quickly provide relevant information to the scanning devices.

Work is proceeding to introduce management systems to manage a wireless local area network (WLAN) extended service set (ESS) that contains two or more WLAN access points (APs). In some scenarios it is possible that the ESS could contain several thousands of APs.

The ESS management systems typically manage the operation of the APs to ensure that the APs are operational and to collect authorization, accounting and access information from the APs.

Of interest to the description of the non-limiting examples of embodiments of this invention is a document: IEEE P802.11, Wireless LANs, “Active Scanning Enabling FILS”, Jarkko Kneckt, Eng Hwee Ong, Mika Kasslin, Gabor Bajko, 2011 November, incorporated by reference herein.

Also of interest to the description of the non-limiting examples of embodiments of this invention is PCT/US11/58346, “Active Scanning in Wireless Network”, 28 Oct. 2011, Jarkko Kneckt, Eng Hwee Ong, Mika Kasslin, Gabor Bajko, incorporated by reference herein.

Probe response collision avoidance mechanisms have been proposed that allow APs to reduce the number of probe responses that are transmitted in response to a received probe request. Two mechanisms are defined to reduce the amount of probe responses:

(A) comprehensive probe responses; and

(B) a combined response to multiple probe requests with a single probe response.

Previous proposals concentrate primarily on the air interface signaling. However, an architecture and operational logic to enable central coordination of the probe-related signaling are not defined. The use of central coordination would control the discovery information distribution from the APs to the discovering terminals to ensure reduction of unnecessary probe response frame transmissions and to also ensure that the most relevant information is received in a timely manner. The centralized coordination can also be used for load distribution purposes so that a more uniform load across all the APs in an ESS can be maintained.

The ESS management system may aid in coordinating an active scanning procedure in order to simplify the discovery of the AP. It may also reduce the overhead of network operation.

A current active scanning mechanism uses enhanced distributed channel access (EDCA) to obtain a transmission opportunity (TXOP) for probe response frames. However, there is no coordination of when the probe responses are applied for transmission. The basic assumption is that the frames are applied for transmission as soon as the responding device has generated the frames.

Simultaneous attempts to transmit the probe response frames can result in collisions and retransmissions, and the resulting delay to transmit the responses increases the scanning duration. However, the transmission of the responses may not need to be a strictly real time operation. In general, it is typically sufficient if the probe response is ready for transmission within a few milliseconds.

The non-limiting examples of embodiments of this invention provide methods and apparatus configured to reduce the overhead of the active scanning procedure and also enable most relevant probe responses to be transmitted first. The non-limiting examples of embodiments of this invention also provide methods and apparatus to enable the traffic loading to be distributed more evenly across the APs of the ESS.

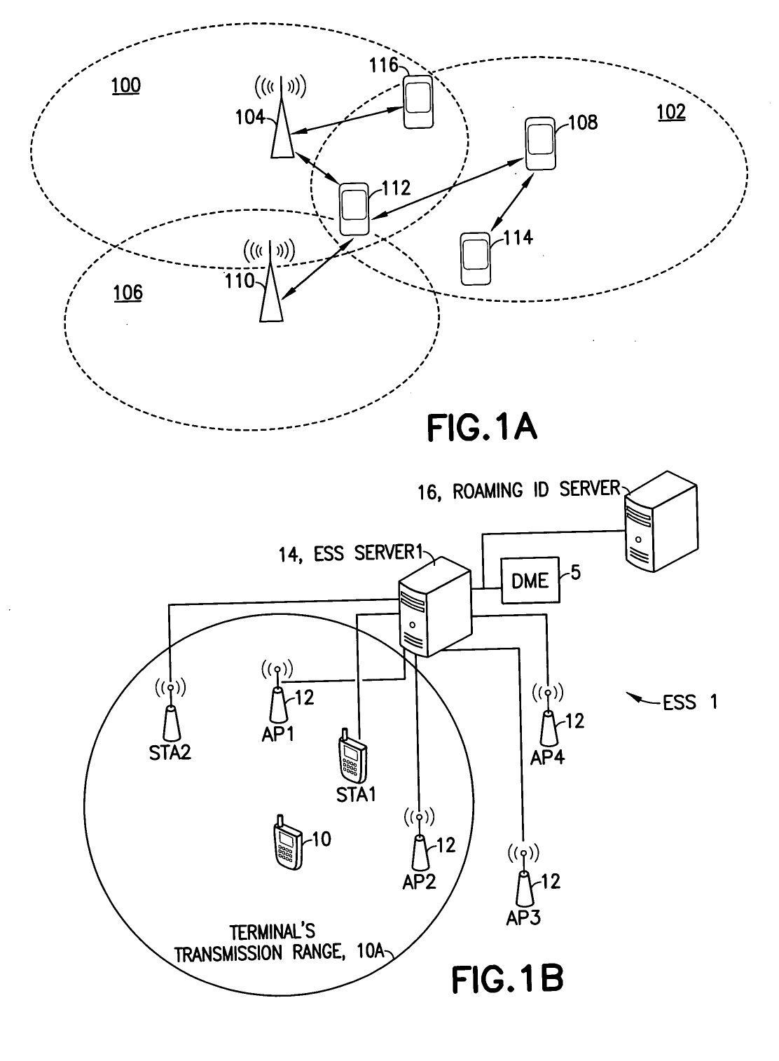

FIG. 1A reproduces FIG. 1 of the above-referenced PCT/US11/58346 and shows a general architecture of a wireless communication system to which embodiments of the invention may be applied. FIG. 1A illustrates groups of wireless communication devices forming wireless networks that may be referred to as basic service sets (BSS). A BSS may be defined by a group of wireless communication devices comprising an access point (AP) 104, 108, 110 and one or more terminal stations (STA) 114, 116 communicating with the access points 108, 104 of their respective groups. The STA 112 ma) be considered to be in an idle or an unassociated state and to be searching for a BSS to connect with. The BSS is a basic building block of an IEEE 802.11 wireless local area network (WLAN), and each BSS may have a determined coverage area 100, 102, 106 defined by the coverage area of the AP, for example. The most common BSS type is an infrastructure BSS that includes a single AP together with all associated, non-access-point STAs. The AP may be a fixed AP as AP 104, 110, or it may be a mobile AP as AP 108. The APs 104, 108, 110 may also provide access to other networks, e.g. the Internet. In another embodiment at least one of the BSSs, is an independent BSS (IBSS) or a mesh BSS (MBSS) without a dedicated AP, e.g., the communication device 108 may in such an embodiment be a non-access-point terminal station.

While embodiments of the invention are described below in the context of the above-described topologies of IEEE 802.11, it should be appreciated that other embodiments of the invention may be applicable to networks based on other specifications, e.g. WiMAX (Worldwide Interoperability for Microwave Access), UMTS LTE (Long-term Evolution for Universal Mobile Telecommunication System), or other networks having, for example, cognitive radio features, e.g. transmission medium sensing features and adaptiveness to coexist with radio access networks based on different specifications and/or standards.

The BSSs are represented by the APs and/or STAs connected to each other, thereby establishing a BSS. Any one of the STAs 112, 114, 116 may establish a connection to any one of the BSSs, provided that the BSSs do not exclude the STAs from their list of devices allowed to connect to the BSSs. The connection establishment may include authentication in which an identity of a STA is established in the AP. The authentication may comprise exchanging an encryption key used in the BSS. The authentication may be based on shared key authentication or on an authentication, authorization and accounting (AAA) protocol, etc. After the authentication, the AP and the STA may carry out association in which the STA is fully registered in the BSS, e.g. by providing the STA with an association identifier (AID) for frame transmissions. For example, the STA 112 may establish a connection to any one of the APs 104, 108, 110.

Reference is now made to FIG. 1B. Assume that a device, such as one of the stations (STA) 10 shown in FIG. 1B, sends a probe request to discover available APs 12 within an area.

In accordance with the non-limiting examples of embodiments of this invention the APs 12 coordinate through a common discovery management entity (DME) 5 (e.g., which could be co-located with an ESS Server 14) their transmissions of discovery response messages to the scanning/discovering devices (STAs 10).

The discovery management entity (DME 5) may specify one or more of the following:

(a) the AP(s) 12 that respond to the Probe Request frames;

(b) the response order of the APs 12, where a most relevant response is transmitted first; and

(c) a Probe Response frame type and the information content of the Probe Response frame.

The use of the non-limiting examples of embodiments of this invention may reduce signaling overheads and the probability of response collisions occurring by using a centralized control architecture and network backbone signaling (between APs 12 and the DME 5) as described in detail below.

The non-limiting examples of embodiments may provide that the probe response discovery information can be used for load balancing of the APs 12 and may also provide for the steering of the scanning devices to associate with an AP 12 that maximizes the performance of the network, where the network may be comprised of multiple BSSs and APs (typically as an ESS).

The non-limiting examples of embodiments of this invention may provide for the inclusion of a new field in a probe response message to indicate that the probe response transmission order has been considered by the network, and that the device (STA 10) is recommended to benefit from associating with the AP 12 whose parameters are provided (received) first.

In FIG. 1B the APs 12 are connected to the discovery management entity 5 that manages transmissions of discover) response messages to devices (STAs 10) that are performing scanning for network discovery purposes, and from which discovery request messages have been received. The discovery management entity 5 is a logical entity that may be implemented, as an example, as a part of the ESS Server 14. The overall network may be referred to as an ESS 1.

The APs 12 of the ESS 1 are connected to the DME 5 at the ESS Server 14 that coordinates Probe Response frame transmissions from the APs 12. There can be other devices (e.g., STA1, STA2) that may operate as an AP in the ESS 1, but are not currently activated to operate as an AP for the ESS 1. These devices can receive probe requests and report received probe requests to the ESS Server 14. The ESS Server 14 may activate these devices and command them to send probe responses and beg,in to operate as an AP in the ESS. Some devices, such as STA1 in FIG. 1B, may be a mobile AP 12, or may operate according to a mesh BSS.

Note that FIG. 1B is a logical depiction of the system architecture and that some illustrated devices may actually be other devices. For instance one of the APs 12 may have the discovery management entity (DME) 5 co-located therewith.

Note also that typically only the interface between the terminal (STA 10) and the AP 12 is wireless and that the other interfaces (e.g., backbone interfaces between the AP 12 and the ESS Server 14) are wired interfaces. However, in some embodiments a wireless interface may be used for this purpose as well.

The discovery management entity 5 may also be under control of, or at least connected to, a Roaming ID Server 16 that may be present in public places (such as shopping malls or airports) that contain networks from different radio access network providers. If in some case the ESS Server 14 cannot serve a new terminal it may request the Roaming ID Server 16 to assign another ESS or to coordinate in which order the ESS information is given to the terminal. The use of the Roaming ID Server 16 may be enforced by contract. For example, the owner of the facility may allow the network installation only if it is connected to the Roaming ID server 16.

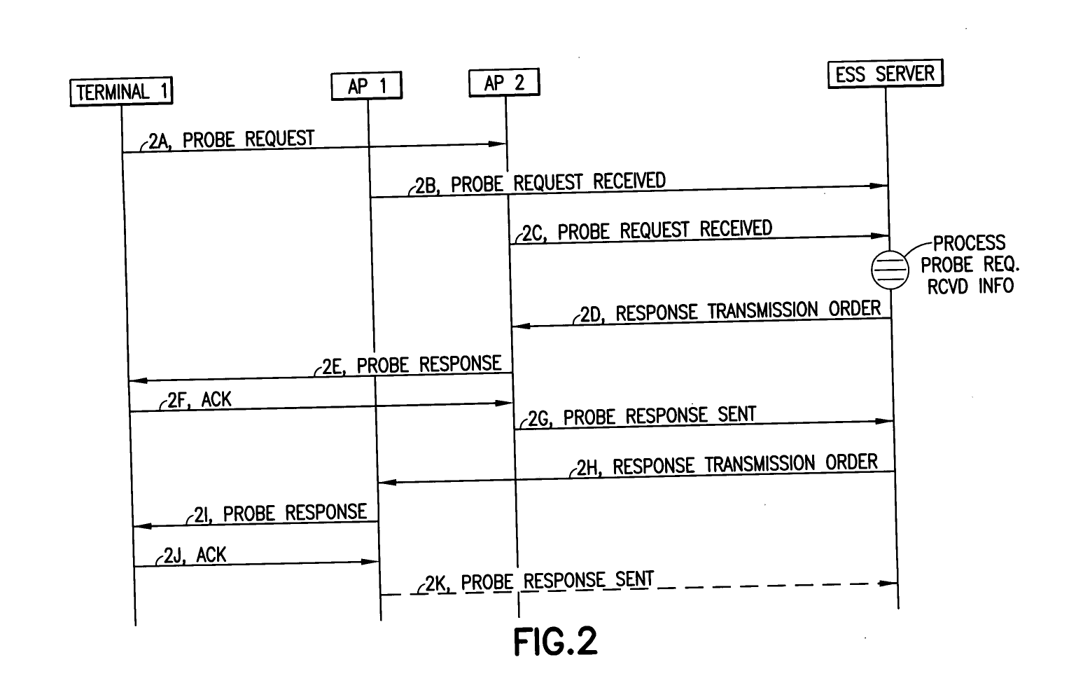

Discussed now with respect to FIG. 2 is an exemplary operation flow for centrally coordinated active scanning. It should be noted that the various illustrated signaling flows and messages and frames are exemplary, and that in some examples of embodiments there may be more or less than the illustrated flows that are actually used. That is, some of the illustrated flows may be optionally not present, and other (un-illustrated) flows may optionally be present.

It should also be noted that the following description is directed to the use of Probe Request frames and Probe Response frames. However, the scanning also contains a Generic Advertisement Service (GAS) Request and GAS Response. The GAS frames have been more specifically used for MAC-level (L2) service discovery and for network discovery. It is desirable to be able to use the Probe Request and Probe Response is a somewhat similar fashion as GAS messages. For clarity purposes the following description is directed just to the use of Probe Request frames and Probe Response frames, however it should be kept in mind that the Probe Request frame could be replaced by the GAS Request frame and the Probe Response frame could be replaced by the GAS Response frame.

Also while the ensuing description and several of the Figures indicate that the Probe Request frame is received by an AP 12, the Probe Request frame could be received by any type or device that is connected to the ESS Server 14 and that can send the Probe Request Received frame to the ESS Server 14.

At 2A the terminal (STA 10 in FIG. 1B) transmits a Probe Request frame to a broadcast address. The Probe Request frame is received by AP1 and AP2 which are within the transmission range 10A of the terminal 10 as shown in FIG. 1B.

At 2B and 2C the APs 1 and 2 respectively may send a “Probe Request Received” frame to the DME 5 which, for the purposes of this non-limiting example, is assumed to be co-located with the ESS Server 14. The “Probe Request Received” frame contains information that comprises, for example, the content of the received Probe Request frame, the time at which the Probe Request frame was received by the AP and the reception power at the AP of the received Probe Request frame. The Probe Request Received frame can also be used to indicate medium measurement results indicating a medium congestion level, the number of associated terminals in the BSS, the number of admission controlled streams in the BSS, and the signal to noise plus interference ratio (SINR). Note that in some cases this type of information may already be readily available in the ESS Server 14 for network management purposes.

After the ESS Server 14 has received the Probe Request Received frames at 2B and 2C the ESS Server 14 processes the information contained in the Probe Request Received frames. The ESS Server 14 may use any other information that it has available concerning the requesting APs 12 when processing the information contained in the Probe Request Received frames. The ESS Server 14 forms “Response Transmission Order” frames and sends them (at 2D) to a selected set of APs 12 (in this example to AP2). The ESS Server 14 may define, as several non-limiting examples, which of the APs that it coordinates and controls are to transmit a Probe Response frame to the discovering device, what type of response is to be used, the maximum number of retransmissions of the Probe Response frames, the receiver address of the probe response (individual or broadcast address), the EDCA parameters to obtain TXOP for the Probe Response frame, and/or the content of the Probe Response frames. The ESS Server 14 may, as an example, determine to command one of more of those APs to transmit a response that the AP(s) did not receive a discovers request and that it did not send a Probe Request Received frame to the ESS Server 14. For example, another AP of the BSS (not shown in FIG. 2) could be commanded to transmit a Probe Response frame to the STA, even though this other AP did not receive the Probe Request frame from the STA.

At least a part of the control information that is provided to the APs 12 in the form of the Response Transmission Order frame may comprise at least some of the following information.

(A) The Response Transmission Order frame may comprise information for a Probe Response frame. In some embodiments the ESS Server 14 may provide additional or special information to be added to the Probe Response frame. The information may also contain identifications of other APs 12, or the ESS Server 14 may fetch the requested information to be added to Probe Response frame.

(B) The information may include a rule as to when the Probe Response frame may be transmitted. For example, if the discovery management entity 5 is in a position to control and determine exact timing of the Response Transmission Order frame transmission, the following procedure may be applied: The ESS Server 14 may enable the Probe Response transmission (2E) only when the Response Transmission Order message is received by the AP 2. Thus, there may be only a single AP (or limited number of APs) contending (TXOP) for Probe Response frames. As shown in FIG. 2, after the Probe Response is successfully transmitted, indicated by an ACK (2F) from the terminal, a Probe Response Sent frame may optionally he sent (2G) from the AP2 to the ESS Server 14. At this point the WOE 5 at the ESS Server 14 may schedule the next AP (e.g., AP1) to transmit the Probe Response frame (2H, 2I). In FIG. 2 the terminal may ACK the Probe Response frame received from AP1 (2J), which may then optionally send the Probe Response Sent frame (2K) to the ESS Server 14.

If the ESS Server operation has delays, for instance if the ESS Server 14 is located far away from the served APs, sending the same Response Transmission Order frame may include additional delays, and the same Response Transmission Order frame may be transmitted to multiple receivers. In this case the Probe Response frame may be allowed to be transmitted only after some certain time period, or after the Probe Response is transmitted by the other AP. The responding APs, order of the responses and/or the delays when the response may be transmitted may be listed. If the AP is not in the list it does not transmit the Probe Response and hence only the responding APs contend for transmitting the Probe Response frame.

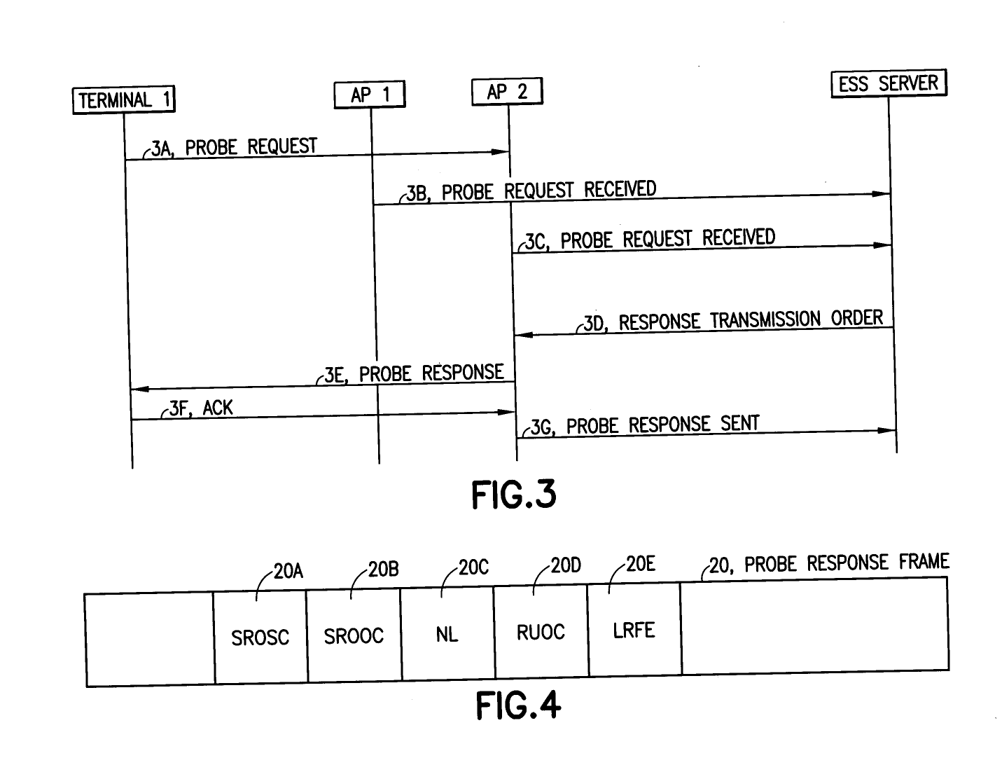

FIG. 3 shows another exemplary signaling diagram to achieve probe response coordination, where a Probe Response frame sent from AP2 includes information of AP1. The message flows 3A-3G correspond to the message flows 2A-2G of FIG. 2 with the exception that the Probe Response frame sent at 3E includes information pertaining to AP2 as well as AP1. In this case the Probe Response frame 21 from AP1 is not needed to be transmitted, and overall wireless signaling overhead may be reduced.

In another example of an embodiment the DME 5 may order only one AP 12, or a limited subset of APs 12, to send the Probe Response(s) even if there are also other APs that received the Probe Request. This Probe Response may not comprise information regarding other APs, just information concerning the transmitting AP. An exemplary reason for this type of operation may be to achieve load balancing within the ESS from a network perspective.

The DME 5 located (by example) at the ESS Server 14 may provide EDCA parameters to be used for the Probe Response frame transmission. These parameters may reduce the delay to transmit the Probe Response.

The DME 5 at the ESS Server 14 may command the AP that is most suitable for the ESS to transmit the Probe Response frame first, and may include a neighbor list for the Probe Response frame to contain information of the most relevant APs in other channels. If the association of a given STA to a particular AP is considered to not be suitable for the ESS, the ESS Server 14 may deny the transmission of the Probe Response frame by that AP.

There can be a number of possible decision criteria used to select the most suitable AP to respond to the scanning device (STA). As one non-limiting example the DME 5 may select the AP based on the received power of the Probe Request messages. In this case the AP reporting the strongest received power in the Probe Request Received frame may be selected as the candidate AP to send the Probe Response frame.

As another non-limiting example the DME 5 may select the AP based on the congestion level of the operating channel of the AP. In this case the AP having the least congested channel may be assumed to provide a good link to the scanning device and may be selected as the candidate AP to send the Probe Response frame.

As another non-limiting example the DME 5 may select the AP based on a combination of at least one PHY (physical, Layer1) metric and at least one link layer metric by using a multi-attribute decision making algorithm. The PHY metric may include one or more of the received signal strength indication (RSSI) and the SINR, while the link layer metric may include one or more of channel utilization, packet delay and packet loss rate, for example. A simple additive weighting (SAW) approach is one suitable algorithm wherein each metric is weighted according to their importance. A SAW cost function Vᵢ to rank AP i is formulated as the weighted sum of the j-th metrics as shown in expression (1) below,

$${V}_{i} = {\sum }_{j = 1}^{n} {w}_{j} {r}_{ij} , \sum {w}_{j} = 1 \qquad ( 1 )$$

where wⱼ is the normalized weight of the j-th metric and rᵢⱼ is the normalized value for the i-th AP and the j-th metric. The AP with the highest SAW cost function value is then selected to send the Probe Response frame.

Further in accordance with the non-limiting examples of embodiments of this invention new information elements (IEs) are included in the Probe Response frame sent from an AP 12 to the STA 10.

The currently defined Probe Response frame format can be found in Section 7.3.2.30, TSPEC element, of IEEE Std 802.11-2007, incorporated by reference herein.

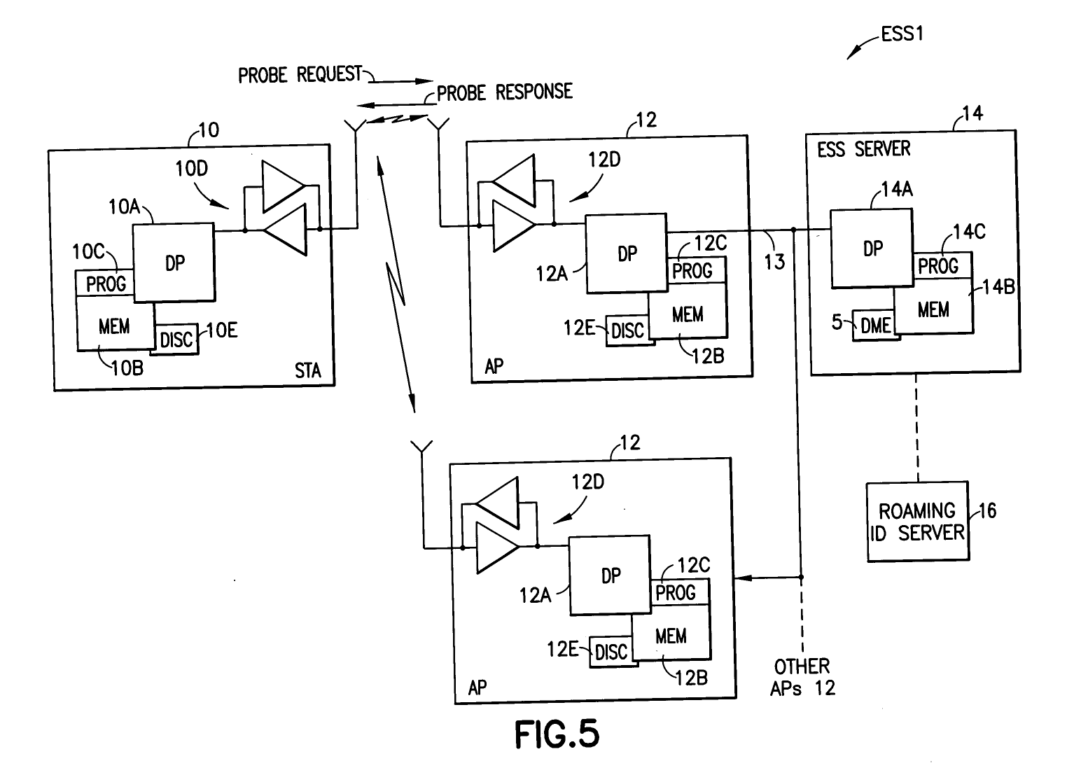

FIG. 4 show s a Probe Response frame 20 having one or more of a new IE referred to as, for example, “Selected Response Order of Scanned Channel” (SROSC 20A), a new IE referred to as, for example, “Selected Response Order of Other Channels” (SROOC 20B), and a new IE referred to as, for example, a Recommend to Use Other Channel field (RUOC 20D). The ordering of the illustrated IEs is not intended to represent any specific ordering or placement of these IEs within the Probe Response frame 20, which is also assumed to include other more conventional IEs and information such as those shown in the above-referenced Section 8.3.3.10 of Draft P802.11-REVmb/D12.

When the Selected Response Order of the Scanned Channel field 20A is set to 1 the receiving STA 10 is informed that the order in which the Probe Response frames are transmitted by the APs 12 have been coordinated by the ESS Server 14. This indicates that the scanning device is recommended to attempt to authenticate and associate to the APs 12 according to the order in which the Probe Response frames are received. In this case the response order is based on the ranked merits of the APs 12 that have received the probe requests. If instead the Selected Response Order of the Scanned Channel field 20A is set to 0 the response order may have no relation to the ranked merits of the APs which have received the probe requests. If the STA 10 does not want to authenticate and associate to the recommended AP it may continue scanning and select another AP for association. However, in this case the scanning procedure can take longer to complete.

When the STA 10 does not desire to receive more probe responses from the channel, it may indicate in the ACK frame that a further Probe Response frame from the other AP is not required. This may be accomplished by setting a More Data field to 1 in the MAC header of the ACK frame of the Probe Response. For instance, the More Data field may be set to 1 in the ACK frame transmitted to response to the Probe Response frame if the scanning device accepts the recommendation to authenticate and associate to the AP that transmits the first or any of the current Probe Response frame(s).

Referring to FIG. 2, the More Data field is set to 1 in the ACK frame (2F), then AP2 will forward a Probe End indication in the Probe Response Sent frame (2G) to the ESS server 14. The ESS server 14, upon receiving the Probe Response Sent frame (2G) with Probe End indication, will cease to transmit further Response Transmission Order frame(s) to the remaining APs 12 which have sent the Probe Request Received frame. Hence, in this example, signaling messages 2H to 2K may be omitted. Otherwise, if the More Data field is set to 0 in the ACK frame (2F), then the signaling messages 2H to 2K remain unchanged.

Alternatively the STA 10 may transmit a Probe End frame to indicate that it is no longer available to receive the transmitted Probe Response frames. If any device that is served by the ESS Server 14 receives the Probe End frame, it transmits the Probe End Received message to the ESS Server. The ESS Server 14 considers the received Probe End Received message and determines whether it sends Response Transmission Order messages to the APs 12.

If the ESS Server 14 desires that the APs 12 transmit Probe Responses even when the scanning transmits Response Transmission Order messages to the APs, the Response Transmission Order messages may set the amount of retransmissions to 0, indicating that no retransmissions are to occur. If any AP is transmitting a Probe Response, the ESS Server 14 may transmit a new Response Transmission Order frame to cancel the transmission of any pending Probe Response frames.

The Probe End frame may set new criteria for Probe Response transmission. For instance, the Probe End frame may allow the Probe Response to be only transmitted from a specific service set identifier (SSID). The ESS Server 14 considers the new limitations when it selects the responding APs 12.

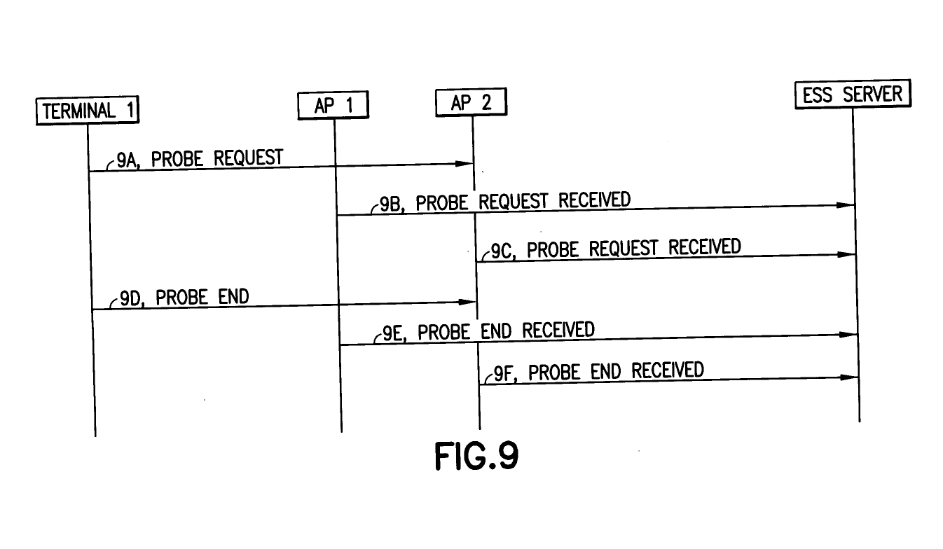

FIG. 9 illustrates an example of the Probe End transmission. In this Figure a Probe End frame 9D indicates that the requesting device w ill not be available to receive any new Probe Response frames. The Probe End frame 9D is received before any Probe Response frame is transmitted. In response to receiving the Probe End frame the receiving AP(s) each send a Probe End Received frame (9E, 9F) to the ESS Server 14.

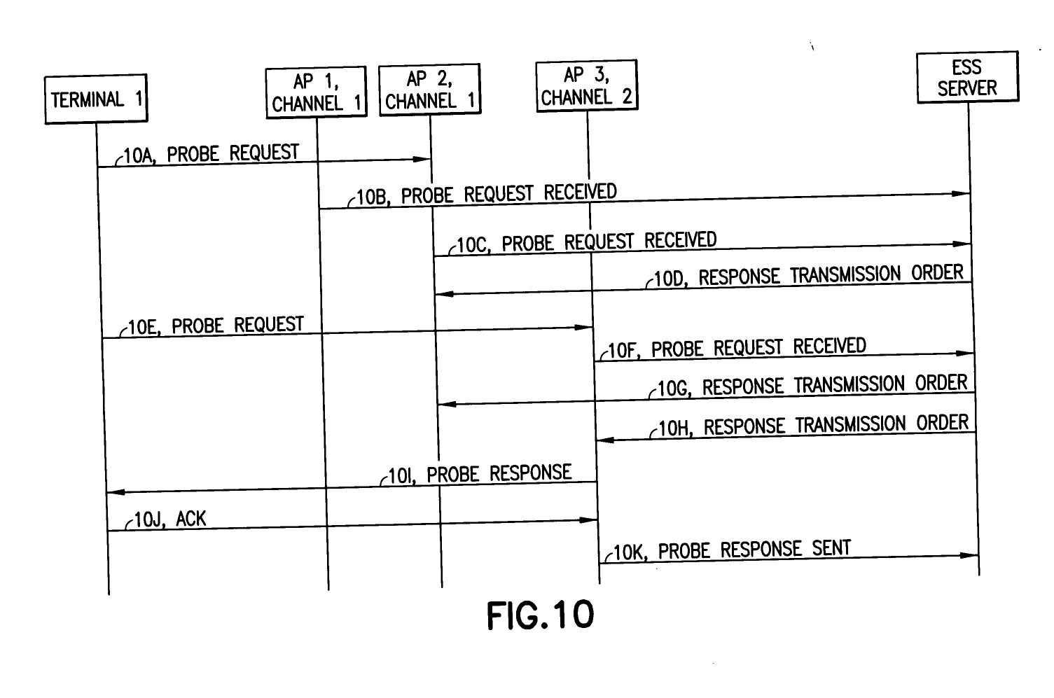

The ESS Server 14 may be connected to APs 12 operating in other channels as shown in FIG. 10. The ESS Server 14 may receive a Probe Request Received frame from each of AP1 and AP2 in channel 1 (10B, 10C) indicating that a Probe Request was transmitted by the terminal (10A). In this non-limiting example the ESS Server 14 transmits a Response Transmission Order frame to AP2 (10D). Before the ESS Server 14 has received a Probe Response Sent frame from AP2, the ESS Server 14 receives a Probe Response Received frame from AP3 in channel 2 (10F). The Probe Response Received frame indicates that AP3 has received a Probe Request from the terminal (10E). Based on the Probe Response Received frame at 10F from AP3, the ESS Server 14 may consider that the scanning terminal has changed the scanned channel and is no longer available to receive the Probe Response frame(s) on channel 1. The ESS Server 14 may thus decide to cancel the Probe Response transmissions at channel 1 and sends a new Response Transmission Order frame to AP2 to cancel the pending Probe Response frames transmission from AP2. The ESS Server 14 does not subsequently send a Response Transmission Order frame to AP1 and AP2 but instead sends a Response Transmission Order frame to AP3 (10H) operating in channel 2. AP3 then sends the Probe Response frame to the terminal (10I), receives the ACK (10J) and may then send the Probe Transmission Sent frame to the ESS Server 14 (10K).

In some embodiments it may be the case that the ESS Server 14 has transmitted the Response Transmission Order frame and the ESS Server 14 then receives a new Probe Request Received frame from APs that are located at a different location. In this case, the ESS Server 14 may consider the location of AP 12 that received the last Probe Request from the terminal and adjust the set of APs 12 that transmit the Probe Response to agree with the location of the AP that received the last Probe Request, thereby adjusting the boundaries of the coverage area for the terminal.

In some embodiments the ESS Server 14 may transmit multiple Response Transmission Order messages for the transmission of the Probe Responses to a single Probe Request. For instance, the ESS Server 14 may command an AP 12 to transmit a single Probe Response frame and command that the Probe Response Sent frame is transmitted after the Probe Response frame transmission if the transmission or the Probe Response was not successful, then the ESS Server 14 may change to another AP 12 to transmit the Probe Response frame. The change of the Probe Response transmitter may aid the ESS Server 14 in detecting the location of the requesting STA 10, and the change of the transmitting AP 12 may improve the likelihood of achieving a successful Probe Response transmission.

Referring again to FIG. 4, the Selected Response Order of Other Channels field 20B is set to 1 to indicate that the BSSs included in a Neighbor List (NL 20C) of the Probe Response frame are listed in an order that is coordinated by the ESS Server 14. In this case it is recommended to the scanning device to attempt to authenticate and associate to the APs according to the order in which they appear in the Neighbor List 20C, as the listing order is based on the ranked merits of the APs 12 which have received the Probe Request frame from the STA 10. If the Selected Response Order of Other Channels field is set to 0 the listing order may have no relationship to the ranked merits of the APs which have received the probe requests.

The Recommend to Use Other Channel field (RUOC 20D) is set to 1 to indicate that the responding AP 12 recommends that the STA 10 select the BSS from the Neighbor List 20C for authentication and association otherwise, when the RUOC field 20D is set to 0, the STA 10 is recommended to select the AP from the scanned channel.

A Last Response from ESS (LRFE) field 20E is set to 1 to indicate that the Probe Response or the Beacon frame with the LRFE bit set to 1 will be the last transmitted Probe Response frame transmitted as a response to the Probe Request frame. When the LRFE field is set to 0, the ESS may send more responses to the Probe Request frame. When the LRFE field is set to 1 the requesting device knows that it should expect at least one more Probe Response frame from the ESS.

It is further noted that it is within the scope of the embodiments of this invention for the ESS Server 14 to wake up ‘sleeping’ APs 12. In one embodiment the APs 12 could listen for Probe Request frames and forward them to the ESS Server 14, and the ESS Server 14 can then determine to wake up certain APs 12 (those that are d down totally or at least partially) to send the Probe Response frames. In another embodiment ‘sleeping’ APs 12 do not forward Probe Request frames. When the ESS Server 14 does receive a forwarded Probe request frame from another AP 12 it can determine to wake up one or more of the sleeping APs 12 to send a Probe Response frame, even if the AP(s) 12 being awakened did not receive and forward any Probe Request frame to the ESS Server 14.

The ‘sleeping’ AP may operate as an AP for some BSS (for at least one BSS) and it may not operate as an AP for all configured BSSs. The AP may reconfigure the BSSs it operates with as an AP based on, for example, ESS Server 14 commands.

The ‘sleeping’ AP may also operate as another device type, for instance as a client, and the device may be commanded to change its operation mode.

In one exemplary embodiment the ESS Server 14 can send a Response Transmission Order to two or more APs 12 indicating a schedule for the Probe Response frame transmission. When the ESS Server 14 sends orders to different APs 12 then their transmission schedules are different. In one embodiment, the ESS Server 14 can send a common message to multiple APs 12 indicating separately the Probe Response frame schedule for each AP 12. For instance, the APs may be configured to transmit their Probe Response frames only when they have received a successfully transmitted Probe Response from a specific AP. Similarly the APs may use a timer-based approach so that when the timer expires they may transmit their Probe Response frame. In general normal EDCA procedures may apply and an AP may monitor transmissions from other APs.

It is pointed out that n general there may be at least two independent decisions to be made by the DME 5 when it receives a Probe Request Received frame (which may be received from but a single AP or from more than one AP). A first decision concerns the order of the APs 12 to which the terminal attempts to associate (content of the Probe Response message). The second decision concerns the determination of the set of APs 12 that respond to the requesting STA (selection of the responding APs). Typically (at least) one of the responding APs also transmits the Probe Response frame.

It should be noted that in some cases the set of APs to which the scanning device tries to associate may be empty, i.e., the BSS may have received a large number of probe requests and the Probe Request sent by the STA may not be answered by a Probe Response.

Reference is made to FIG. 5 for illustrating a simplified block diagram of various electronic devices and apparatus that are suitable for use in practicing the non-limiting examples of embodiments of this invention. In FIG. 5 a wireless network, such as the ESS 1, is adapted for communication over wireless links with an apparatus, such as a mobile communication device which may be referred to as the STA 10, via network access nodes, such as the APs 12. The ESS 1 also includes the ESS Server 14 which in turn can be connected with the Roaming ID server 16 shown in FIG. 1B. The APs 12 can provide connectivity with further networks such as data communications network (e.g., the Internet).

The STA 10 includes a controller, such as at least one computer or a data processor (DP) 10A, at least one non-transitory computer-readable memory medium embodied as a memory (MEM) 10B that stores a program of computer instructions (PROG) 10C, and at least one suitable radio frequency (RF) transmitter and receiver pair (transceiver) 10D for bidirectional wireless communications with the APs 12 via one or more antennas. The APs 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the STA 10 via one or more antennas. The APs are coupled via a data/control path 13 to the ESS Server 14. The path 13 may be considered as an ESS backbone connection or distribution system.

For the purposes of describing the non-limiting examples of embodiments of this invention the STA 10 can be assumed to also include a Discovery (DISC) function or module 10E, the APs can be assumed to include a Discovery (DISC) function or module 12E, and the ESS Server can be assumed, in this non-limiting embodiment, to include a function or module the implements the DME 5. The STA 10 Discovery (DISC) function or module 10E can be assumed to operate to transmit the Probe Request frames and to receive and correctly interpret the enhanced Probe Response frames 20 received from the APs 12. In an embodiment the AP 12 Discovery (DISC) function or module 12E may be assumed to operate to receive the Probe Request frames and to format and transmit the enhanced Probe Response frames 20 in cooperation with the Response Transmission Order frames received from the ESS Server 14. The DME 5 of the ESS Server 14 may be assumed to operate as described above to receive the Probe Request Received frames from the APS 12, to process and analyze the information contained in these frames and, in response, to format and send the Response Transmission Order frames to the APs 12. The processing and analyzing of the information received in the Probe Request Received frames may include determining an ordering of the APs 12 for sending their respective Probe Response frames, which in turn may include making AP-related load balancing determinations as discussed above.

Note again that the DME 5 could be located elsewhere in the ESS 1 (i.e., it need not be co-located with the ESS Server 14).

The programs 10C, 12C and 14C are assumed to include program instructions that, when executed by the associated data processor, enable the device to operate in accordance with the non-limiting examples of embodiments of this invention. The non-limiting examples of embodiments of this invention may be implemented at least in part by computer software executable by the data processors 10A, 12A and 14A, or by hardware, or by a combination of software and hardware (and firmware). In particular, the DISC modules 10E and 12E and/or the DME 5 may be implemented wholly as computer software executable by the data processors 10A, 12A and 14A, respectively, or wholly in hardware, or by a combination of software and hardware (and firmware).

The various data processors, memories, programs, transceivers and interfaces depicted in FIG. 5 may all be considered to represent means for performing operations and functions that implement the several non-limiting aspects and embodiments of this invention.

The various embodiments of the STA 10 may include, but are not limited to, cellular mobile devices, phones and smartphones having WLAN wireless communication capabilities, personal digital assistants (PDAs) having wireless communication capabilities, portable computers having wireless communication capabilities, tablet and notebook type computing devices having wireless communication capabilities, electronic reader type devices having wireless communication capabilities, image capture devices such as digital cameras having wireless communication capabilities, gaming devices having wireless communication capabilities, music storage and play back appliances having wireless communication capabilities, Internet appliances permitting wireless Internet access and browsing, as well as portable units or terminals that incorporate combinations of such functions.

The computer-readable memories 10B, 12B 14B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The data processors 10A, 12A and 14A may be of any type suitable to the local technical environment, and may include one or more of general purpose computers, special purpose computers, microprocessors, digital signal processors (DSPs) and processors based on multi-core processor architectures, as non-limiting examples.

There are a number o f advantages and technical effects that may be realized by the use of the non-limiting examples of embodiments of this invention. For example, the transmission of the Probe Response frames may be optimized as fewer Probe Responses may be transmitted. Furthermore, information may be organized for ESS efficiency purposes so as to offer the most relevant information first to the scanning device. Furthermore, the ESS Server 14 may enhance the load distribution amongst the APs 12 by recommending that the STA 10 associate with a particular AP 12 via the information contained in the Probe Response frame.

Based on the foregoing it should be apparent that the non-limiting examples of embodiments of this invention provide a method, apparatus and computer program(s) to enhance the operation of a STA 10 in the ESS 1.

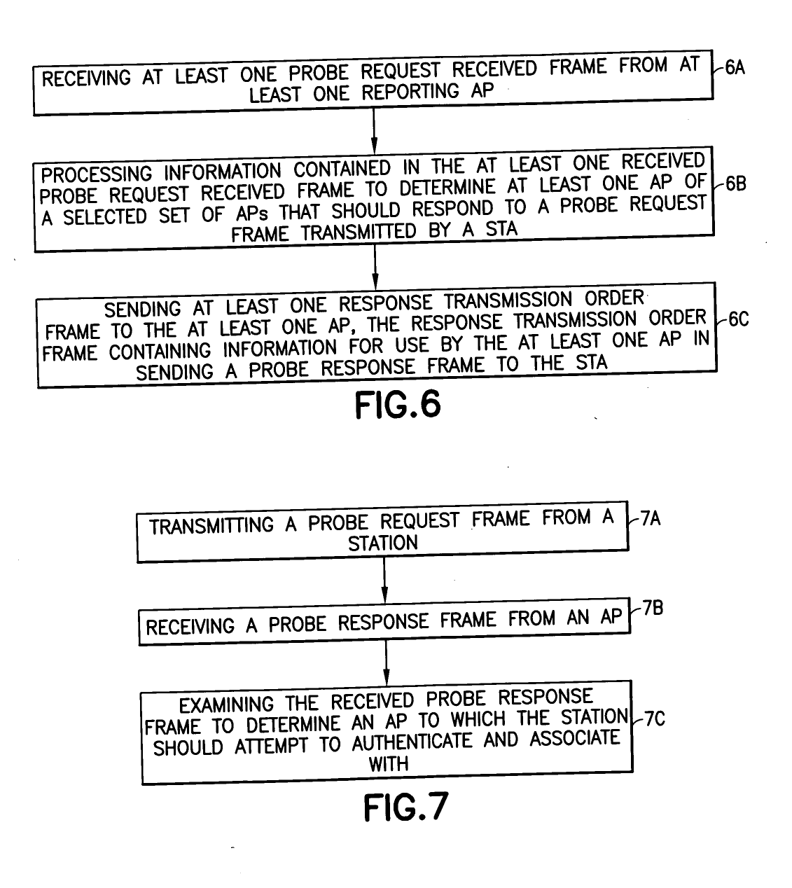

FIG. 6 is a logic flow diagram that illustrates the operation of a method, and a result of execution of computer program instructions, in accordance with the non-limiting examples of embodiments of this invention. In accordance with these non-limiting examples of embodiments a method performs the operations as set forth in the following clauses.

Clause 1: At Block 6A there is a step of receiving at least one Probe Request Received frame from at least one reporting AP. At Block 6B there is a step of processing information contained in the at least one received Probe Request Received frame to determine at least one AP of a selected set of APs that should respond to a Probe Request frame transmitted by a STA. At Block 6C there is a step of sending at least one Response Transmission Order frame to the at least one AP, the Response Transmission Order frame containing information for use by the at least one AP in sending a Probe Response frame to the STA.

Clause 2: The method as in Clause 1 where the step of processing information contained in the at least one received Probe Request Received frame further comprises determining an order in which a STA that transmitted a Probe Request frame to the at least one reporting AP should attempt to associate with the selected set of APs.

Clause 3: The method as in Clause I where the step of processing information contained in the received Probe Request Received frames further comprises determining which APs belong to the set of APs.

Clause 4: The method as in Clause 1 where the step of processing information contained in the received Probe Request Received frames further comprises determining a Probe Response frame type and an information content for the Probe Response frame.

Clause 5: The method as in Clause 1 where the step of processing information contained in the received Probe Request Received frames further comprises a consideration of the power at which each AP received the Probe Request frame from the STA.

Clause 6: The method as in Clause 1 where the step of processing the information contained in the received Probe Request Received frames further comprises considering other information not contained in the received Probe Request Received frames.

Clause 7: The method as in Clause 1 where the step of processing the information further comprises considering a congestion level of operating channels of the APs.

Clause 8: The method as in Clause 1 where the step of processing the information further comprises jointly considering at least one physical layer metric and at least one link layer metric.

Clause 9: The method as in Clause 8, where the physical layer metric comprises one or more of a received signal strength indication (RSSI) and a signal to noise plus interference ratio (SINR), where the link layer metric comprises one or more of channel utilization, packet delay and packet loss rate, and where jointly considering comprises the use of a simple additive weighting (SAW) algorithm.

Clause 10: The method as in Clause 1, where sending the at least one Response Transmission Order frame sends the Response Transmission Order frame to a first AP of the selected set of APs, further comprising waiting to receive a Probe Response Sent frame from the first AP and, in response, sending the Response Transmission Order frame to a second AP of the selected set of APs.

Clause 11: The method as in Clause 1, where sending the at least one Response Transmission Order frame sends the Response Transmission Order frame to a first AP of the selected set of APs, where the Response Transmission Order frame comprises information regarding a neighbor list of other APs.

Clause 12: The method as in Clause 1, where sending the at least one Response Transmission Order frame sends the Response Transmission Order frame to an AP that is currently sleeping in order o wake up the AP to send the Probe Response frame.

Clause 13: The method as in Clause 1, where sending the at least one Response Transmission Order frame sends the Response Transmission Order frame to multiple APs, and where the Response Transmission Order frame comprises scheduling information for scheduling the transmission of Probe response frames by the multiple APs.

Clause 14: The method as in Clause 1, further comprising after receiving a Probe Request Received frame from an AP, receiving a Probe End Received frame from the same or a different AP, the Probe End Received frame being originated in response to the Probe End frame transmitted by the station that originally transmitted the Probe Request frame.

Clause 15: The method as in Clause 1 further comprising, after sending a first Probe Transmission Order frame to a first AP communicating with the station in a first channel, receiving a Probe Request Received frame from a second AP communicating with the same station in a second channel and, in response, informing the first AP to cancel the transmission of a Probe Response frame to the station and sending a Probe Transmission Order frame to the second AP to cause the second AP to send a Probe Response frame to the station.

Clause 16: The method as in Clause 15, where informing the first AP to cancel the transmission of a Probe Response frame comprises sending a second Probe Transmission Order frame to the first AP.

Clause 17: The method as in Clause 1, where a station functions as an AP and transmits a Probe Response frame.

Clause 18: The method as in any one of the Clauses 1-17, where the method is executed by a common discovery management entity (DME).

Clause 19: The method as in Clause 18, here DME is co-located with an ESS Server that is connected via a backbone network with the plurality of APs.

Clause 20: A non-transitory computer-readable medium that contains software program instructions, where execution of the software program instructions by at least one data processor results in performance of operations that comprise execution of the method of any one of Clauses 1-19.

FIG. 7 is a logic flow diagram that illustrates the operation of a method, and a result of execution of computer program instructions, further in accordance with the non-limiting examples of embodiments of this invention. In accordance with these non-limiting examples of embodiments a method performs the operations as set forth in the following clauses.

Clause 1: At Block 7A there is a step of transmitting a Probe Request frame from a station. At Block 7B there is a step of receiving a Probe Response frame from an AP. At Block 7C there is a step of examining the received Probe Response frame to determine an AP to which the station should attempt to authenticate and associate with.

Clause 2: The method as in Clause 1, where examining the received Probe Response frame comprises examining a Selected Response Order of the Scanned Channel field, and if this field is set the station is informed that an order in Which Probe Response frames are received from the AP and other APs have been coordinated and that the station is recommended to attempt to authenticate and associate to the APs according to the order in which the Probe Response frames are received.

Clause 3: The method as in Clause 1, where examining the received Probe Response frame comprises examining a Selected Response Order of Other Channels field, and if this field is set the station is informed that basic service sets (BSSs) included in a Neighbor List of the Probe Response frame are listed in an order that has been coordinated and that the station is recommended to attempt to authenticate and associate to the APs according to the order in which they appear in the Neighbor List.

Clause 4: The method as in Clause 1, where examining the received Probe Response frame comprises examining a Recommend to Use Other Channel field, and if this field is set the station is informed that the AP that transmitted the Probe Response frame recommends that the station select a basic sen, ice set included in a Neighbor List of the Probe Response frame for authentication and association, otherwise if this field is not set the station selects the AP from a scanned channel.

Clause 5: The method as in Clause 1, where examining the received Probe Response frame comprises examining a Last Response from ESS (LRFE) field, and if this field is set the station is informed that the Probe Response frame with the LRFE set will be a last Probe Response frame that is transmitted as a response to a Probe Request frame transmitted by the station.

Clause 6: The method as in Clause 1, further comprising transmitting a Probe End frame prior to receiving a Probe Response frame.

Clause 7: A non-transitory computer-readable medium that contains software program instructions, where execution of the software program instructions by at least one data processor results in performance of operations that comprise execution of the method of any one of Clauses 1-6 associated with FIG. 7.

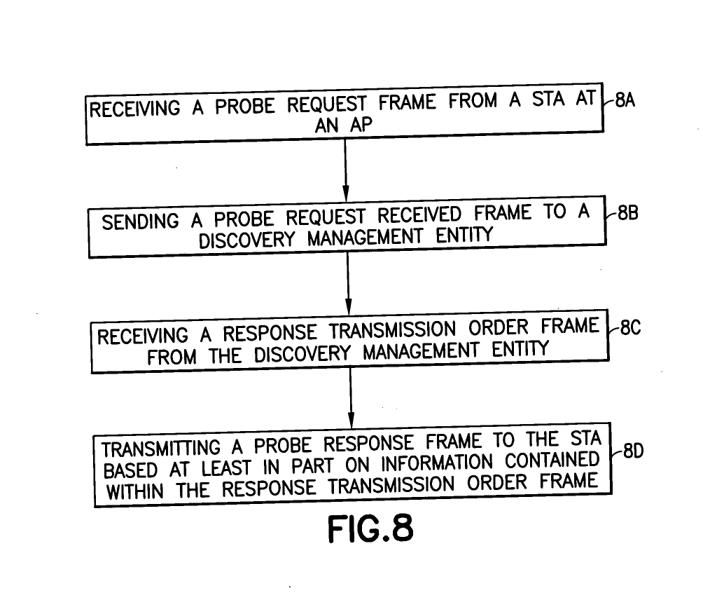

FIG. 8 is a logic flow diagram that illustrates the operation of a method, and a result of execution of computer program instructions, further in accordance with the non-limiting examples of embodiments of this invention. In accordance with these non-limiting examples of embodiments a method performs the operations as set forth in the following clauses.

Clause 1: At Block 8A there is a step of receiving a Probe Request frame from a STA at an AR At Block 8B there is a step of sending a Probe Request Received frame to a discovery management entity (DME). At Block 8C there is a step of receiving a Response Transmission Order frame from the DME. At Block 8D there is a step of transmitting a Probe Response frame to the STA based at least in part on information contained within the Response Transmission Order frame.

Clause 2: The method as in Clause 1 where the step of transmitting the Probe Response frame to the STA comprises determining a Probe Response frame type and an information content of the Probe Response frame based on information contained in the received Response Transmission Order frame.

Clause 3: The method as in Clause 1 where the step of sending the Probe Request Received frame to the DME includes sending information regarding the power at which the Probe Request frame was received from the STA.

Clause 4: The method as in Clause 1 where the step of sending the Probe Request Received frame to the DME includes sending information regarding a congestion level of operating channels.

Clause 5: The method as in Clause 1 where the step of sending the Probe Request Received frame to the DME includes sending information regarding one or more of a received signal strength indication (RSSI), a signal to noise plus interference ratio (SINR), channel utilization, packet delay and packet loss rate.

Clause 6: The method as in Clause 1, where receiving the Response Transmission Order frame wakes up the AP that receives the Response Transmission Order frame to send the Probe Response frame.

Clause 7: The method as in Clause 1, where sending the Probe Response frame comprises setting a Selected Response Order of the Scanned Channel field of the Probe Response frame to inform the STA that an order in which Probe Response frames received from the AP and other APs have been coordinated, and that the STA is recommended to attempt to authenticate and associate to the APs according to the order in which the Probe Response frames are received.

Clause 8: The method as in Clause 1, where sending the Probe Response frame comprises setting a Selected Response Order of Other Channels field to inform the STA that basic service sets (BSSs) included in a Neighbor List of the Probe Response frame are listed in an order that has been coordinated and that the STA is recommended to attempt to authenticate and associate to the APs according to the order in which they appear in the Neighbor List.

Clause 9: The method as in Clause 1, where sending the Probe Response frame comprises setting a Recommend to Use Other Channel field to inform the STA that the AP that transmitted the Probe Response frame recommends that the station select a basic service set included in a Neighbor List of the Probe Response frame for authentication and association, otherwise if this field is not set the station is to select the AP from a scanned channel.

Clause 10: The method as in Clause 1, where sending the Probe Response frame comprises setting a Last Response from ESS (LRFE) field to inform the STA that the Probe Response frame with the LRFE field set will be a last Probe Response frame that is transmitted as a response to a Probe Request frame transmitted by the STA.

Clause 11: The method as in Clause 1, further comprising after sending the Probe Request Received frame receiving a Probe End frame from the STA and, in response, sending a Probe End Received frame to the DME.

Clause 12: The method as in Clause 1, further comprising after receiving the Response Transmission Order frame from the DME receiving another Response Transmission Order frame from the DME and, in response, cancelling the sending of the Probe Response frame to the STA.

Clause 13: The method as in Clause 1, where the DME is co-located with an ESS Server that is connected to a plurality of APs.

Clause 14: A non-transitory computer-readable medium that contains software program instructions, where execution or the software program instructions by at least one data processor results in performance of operations that comprise execution of the method of any one of Clauses 1-13 associated with FIG. 8.

The various blocks shown in FIGS. 6, 7 and 8 may be viewed as method steps, and/or as operations that result from operation of computer program code, and/or as a plurality of coupled logic circuit elements constructed to carry out the associated function(s).

In general, the various non-limiting examples of embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the non-limiting examples of embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, the non-limiting examples of embodiments also encompass an apparatus that comprises at least one data processor and at least one memory including computer program code. The at least one memory and computer program code are configured, with the at least one data processor, to cause the apparatus at least to receive at least one Probe Request Received frame from at least one AP, to process information contained in the at least one received Probe Request Received frame to determine at least one of a selected set of APs that should respond to a Probe Request frame transmitted by a STA and an order in which the STA that transmitted the Probe Request frame should attempt to associate with the selected set of APs, and to send at least one Response Transmission Order frame to at least one of the APs. where the Response Transmission Order frame contains information for use by the at least one AP in sending a Probe Response frame to the STA.

The non-limiting examples of embodiments also encompass a further apparatus that comprises at least one data processor and at least one memory including computer program code. The at least one memory and computer program code are configured, with the at least one data processor, to cause the apparatus at least to transmit a Probe Request frame from a station, to receive a Probe Response frame from an AP, and to examine the received Probe Response frame to determine an AP to which the station should attempt to authenticate and associate with.

The non-limiting examples of embodiments also encompass another apparatus that comprises at least one data processor and at least one memory including computer program code. The at least one memory and computer program code are configured, with the at least one data processor, to cause the apparatus at least to receive a Probe Request frame from a STA, to send a Probe Request Received frame to an ESS Server, to receive a Response Transmission Order frame from the ESS Server and to transmit a Probe Response frame to the STA based on information contained within the Response Transmission Order frame.

It should thus be appreciated that at least some aspects of the non-limiting examples of embodiments of the inventions may be practiced in various components such as integrated circuit chips and modules, and that the non-limiting examples of embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the non-limiting examples of embodiments of this invention.

Various modifications and adaptations to the foregoing non-limiting examples of embodiments of this invention may become apparent to those skilled in the relevant arts in view of the foregoing description, when read in conjunction with the accompanying drawings. However, any and all modifications will still fall within the scope of the non-limiting examples of embodiments of this invention.

For example, while the non-limiting examples of embodiments have been described above in the context of the WLAN system, it should be appreciated that the non-limiting examples of embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters, fields and information elements are not intended to be limiting in any respect, as these parameters, fields and information elements may be identified by any suitable names. Further, the formulas and expressions disclosed above are but examples, and other formulas and expressions can be used.

Furthermore, some of the features of the various non-limiting examples of embodiments of this invention may be used to advantage without the corresponding use of other features. As such, the foregoing description should be considered as merely illustrative of the principles, teachings and non-limiting examples of embodiments of this invention, and not in limitation thereof.

What is claimed is:

1. A method comprising:
receiving at least one probe request received frame from at east one reporting access point;
processing information contained in the at least one received probe request received frame to determine at least one access point of a selected set of access points that should respond to a probe request frame transmitted by a station; and
sending at least one response transmission order frame to the at least one access point, the response transmission order frame containing information for use by the at least one access point in sending a probe response frame to the station.

2. The method of claim 1, where processing information contained in the at least one received probe request received frame further comprises determining an order in which a station that transmitted a probe request frame to the at least one reporting access point should attempt to associate with the selected set of access points.

3. The method of claim 1, where processing information contained in the at least one received probe request received frame further comprises determining a probe response frame type and an information content for the probe response frame.

4. The method of claim 1, where sending the at least one response transmission order frame sends the response transmission order frame to an access point that is currently sleeping in order to wake up the access point to send the probe response frame.

5. An apparatus, comprising:
at least one processor; and
at least one memory including computer program code, where the memory and computer program code are configured to, with the at least one processor, cause the apparatus at least to receive at least one probe request received frame from at least one reporting access point; process information contained in the at least one received probe request received frame to determine at least one access point of a selected set of access points that should respond to a probe request frame transmitted by a station; and send at least one response transmission order frame to the at least one access point, the response transmission order frame containing information for use by the at least one access point in sending a probe response frame to the station.

6. The apparatus of claim 5, where the memory and computer program code are further configured with the at least one processor, when processing the information contained in the at least one received probe request received frame, to determine an order in which a station that transmitted a probe request frame to the at least one reporting access point should attempt to associate with the selected set of access points.

7. The apparatus of claim 5, where the memory and computer program code are further configured with the at least one processor, when processing the information contained in the at least one received probe request received frame, to determine a probe response frame type and an information content for the probe response frame.

8. The apparatus of claim 5, where the memory and computer program code are further configured with the at least one processor to send the response transmission order frame to an access point that is currently sleeping in order to wake up the access point to send the probe response frame.

9. A method comprising:
receiving a probe request frame from a station;
sending a probe request received frame to a discovery management entity;
receiving a response transmission order frame from the discovery management entity; and
transmitting a probe response frame to the station based at least in part on information contained within the response transmission order frame.

10. The method of claim 9, where transmitting the probe response frame to the station comprises determining a probe response frame type and an information content of the probe response frame based on information contained in the received response transmission order frame.

11. The method of claim 9, where sending the probe request received frame to the discovery management entity comprises sending information regarding one or more of a received signal strength indication (RSSI), a signal to noise plus interference ratio (SINR), channel utilization, packet delay and packet loss rate.

12. The method of claim 9, where sending the probe response frame comprises including information to inform the station that an order in which probe response frames are received from access points has been coordinated, and that the station is recommended to attempt to authenticate and associate to the access points according to the order in which probe response frames are received.

13. An apparatus, comprising:
at least one processor; and
at least one memory including computer program code, where the memory and computer program code are configured to, with the at least one processor, cause the apparatus at least to receive a probe request frame from a station; send a probe request received frame to a discovery management entity; receive a response transmission order frame from the discovery management entity; and transmit a probe response frame to the station based at least in part on information contained within the response transmission order frame.

14. The apparatus of claim 13, where the memory and computer program code are further configured with the at least one processor, when transmitting the probe response frame to the station, to determine a probe response frame type and an information content of the probe response frame based on information contained in the received response transmission order frame.

15. The apparatus of claim 13, where the memory and computer program code are further configured with the at least one processor, when sending the probe request received frame to the discovery management entity, to send information regarding one or more of a received signal strength indication (RSSI), a signal to noise plus interference ratio (SINR), channel utilization, packet delay and packet loss rate.

16. The apparatus of claim 13, where the memory and computer program code are further configured with the at least one processor, when transmitting the probe response frame to the station, to inform the station that an order in which probe response frames are received from access points has been coordinated, and that the station is recommended to attempt to authenticate and associate to the access points according to the order in which probe response frames are received.

17. A method comprising:
transmitting a probe request frame from a station;
receiving a probe response frame from an access point; and
examining the received probe response frame to determine whether an order in which probe response frames are received from the access point and from other access points has been coordinated and that the station is recommended to attempt to authenticate and associate to the access points according to the order in which the probe response frames are received.

18. The method of claim 17, where examining the received probe response frame comprises examining a predetermined field and, if the field is set, being informed that the access point that transmitted the probe response frame recommends that the station select a basic service set included in a neighbor list of the probe response frame for authentication and association.

19. An apparatus, comprising:
a least one processor; and
at least one memory including computer program code, where the memory and computer program code are configured to, with the at least one processor, cause the apparatus at least to transmit a probe request frame from a station; receive a probe response frame from an access point; and examine the received probe response frame to determine whether an order in which probe response frames are received from the access point and from other access points has been coordinated and that the station is recommended to attempt to authenticate and associate to the access points according to the order in which the probe response frames are received.

20. The apparatus of claim 19, where the memory and computer program code are further configured with the at least one processor, when examining the received probe response frame, to examine a predetermined field and, if the field is set, to be informed that the access point that transmitted the probe response frame recommends that the station select a basic service set included in a neighbor list of the probe response frame for authentication and association.
